(19) United States
(12) Patent Application Publication
(10) Pub. No.: US 2001/0035382 A1
(43) Pub. Date: Nov. 1, 2001

(54) Swimming pool cleaning apparatus and method of operating the apparatus

(76) Inventor: Patrick McCullagh, Killara (AU)

Correspondence Address: Pillsbury Madison & Sutro LLP, Intellectual Property Group, Suite 200, 11975 El Camino Real, San Diego, CA, 92101-8219, US

(21) Appl. No.: 09/790,481

(22) Filed: Feb. 21, 2001

(30) Foreign Application Priority Data
Feb. 21, 2000 (AU) PQ5719

(51) Int. Cl. B01D 35/05

(52) U.S. Cl. 210/767; 210/169; 210/435

(57) ABSTRACT

The present invention relates to pool cleaning apparatus of the type incorporating a hose for feeding water to a cleaning head for cleaning the bottom of a swimming pool utilising the water from the pool and a method of selectively raising and sinking the hose of the pool cleaning apparatus. In particular, the apparatus comprises a hose for placement in the pool and directing the water from a pump to the cleaning head, the hose having an inlet end for entry of the water into the hose and an outlet end for passage of the water from the hose to the cleaning head. The hose is adapted for being raised in the pool by an increase in buoyancy caused by an increase in pressure of water in the hose with flow of the water along the hose to the cleaning head, and for sinking in the pool upon the pressure of water in the hose being reduced. Accordingly, the hose of the pool cleaning apparatus may be raised by pumping water along within the hose toward the cleaning head to thereby cause the increase of buoyancy and be caused to rink in the pool by reducing the pressure of the water in the hose to thereby reduce the buoyancy.

### FIELD OF THE INVENTION

The present invention relates to a swimming pool cleaning apparatus having a hose which is able to be selectively caused to rise in the pool and float at or in the vicinity of the surface of the water or to sink from the floating position.

### BACKGROUND OF THE INVENTION

Cleaning apparatus of the type having a hose connected to a cleaner head wherein water of the pool is recirculated through the hose to the cleaning head are known in the art. Generally, the water from the hose creates an inflow of surrounding pool water into a perforated catchment bag carried by the cleaner head which draws debris on the floor of the pool in the local area of the cleaner head into the catchment bag, as the cleaner head is moved along the pool floor. The perforations in the catchment bag are dimensioned to allow water to pass through the bag while the debris is retained therein. While such cleaning apparatus provide an adequate cleaning function, the hose tends to float on or near the surface of the pool for a significant period of time when the apparatus is not in use which can obstruct free use of the pool, However, movement and so operation of the cleaning apparatus can be inhibited when the hose is submerged.

Swimming pool cleaning apparatus wherein the water is drawn into the hose from the pool through the cleaner head by a suction pump prior to being recirculated back into the pool are also known in the art. In particular, Austalian Patent No. 608958 and International Patent Application No. PCT/AU98/00369 describe apparatus of this type in which the flow of water within the hope from the pool is produced by the generation of a negative pressure by the suction pump which causes air to be drawn into the bladder and the hose to thereby rise in the pool as a result of increased buoyancy. Removing the negative pressure in the hose causes the air to leave the bladder and the hose to sink in the pool.

However, significantly different pressure effects are produced by pumping the water along the hose into the pool and it is believed that to date, no arrangement for causing the raising and sinking of the hose utilising an increased pressure of water in the hose has been successfully provided, requiring users of pools in which this type of pool cleaning apparatus have been fitted to either remove the hose prior to use of the pool or leave the hose in the pool which can significantly obstruct the free use of the pool.

### SUMMARY OF THE INVENTION

It is an aim of the present invention to ameliorate one or more problems of prior art, or to at least provide alternative pool cleaning apparatus of the type incorporating a hose for feeding water to a cleaning head for cleaning the bottom of a swimming pool utilising the water from the pool or a method of selectively raising and sinking the hose of such pool cleaning apparatus.

In a first aspect of the present invention there is provided a method for selectively raising and sinking a hose of pool cleaning apparatus of the type with a cleaning head for cleaning the bottom of a swimming pool utilizing water from the pool, wherein the hose has an inlet end for entry of water into the hose and an opposite end for the water to exit from the hose to the cleaning head, comprising:

pumping water along within the hose toward the cleaning head such that pressure of the water is increased to thereby cause an increase in buoyancy such that the hose rises in the pool; and

reducing the pressure of the water within the hose, whereby the buoyancy decreases and the hose sinks in the pool.

Preferably, the reducing of the pressure of the water in the hose will comprise reducing the rate at which the water is pumped along the hose.

The pool cleaning apparatus may incorporate a housing which opens into the interior of the hose, and wherein the pumping of the water along the hose causes water to flow into the housing from the hose whereby the buoyancy is caused to be increased.

Moreover, the housing may house a piston wherein the flow of water into the housing from the hose drives the piston in one direction to produce the increase in buoyancy, and wherein said reducing of the pressure of the water in the hose causes the piston to return in an opposite direction decreasing the buoyancy and the water to be expelled from the housing.

Accordingly, in another aspect of the present invention there is provided a pool cleaning apparatus of the type with a cleaning head for cleaning the bottom of a swimming pool utilising water returning to the pool, and further comprising:

a hose for placement in the pool and directing the water from a pump to the cleaning head, the hose having an inlet end for entry of the water into the hose and outlet end for passage of the water from the hose to the cleaning head;

wherein the hose is adapted for being raised in the pool from an initial position to a working position by an increase in buoyancy caused by increased pressure of the water in the hose with flow of the water along the hose to the cleaning head, and subsequently sinking from the working position upon the pressure of the water in the hose being reduced.

Preferably, the pool cleaning apparatus will comprise buoyancy means for facilitating the raising and sinking of the hose and arranged for being at least partly filled with a gas as a consequence of the increase in pressure of the water in the hose and thereby provide the increase in buoyancy, and for holding the gas until the pressure of the water in the hose is reduced such that the hose is thereby able to sink from the working position. The apparatus may also comprise a housing which opens into the interior of the hose and houses a gas reservoir that opens into the buoyancy means, wherein the buoyancy means is arranged exterior of the housing for receiving the gas from the gas reservoir upon the gas being expelled from the reservoir by the flow of water into the housing from the hose.

In another embodiment, the pool cleaner apparatus may comprise a housing which contains the gas and is adapted for receiving water into a bottom region of the housing from the hose as a consequence of the increase in pressure of the water in the hose, the housing having a port defined in an upper region of the housing for passage of the gas into the buoyancy means upon being expelled from the housing by the flow of the water into the housing and for the return of the gas into the housing from the buoyancy means upon the pressure of the water in the hose being reduced.

The buoyancy means as described above may be a bladder or for instance an elongate tube.

In another embodiment the pool cleaning apparatus may comprise a housing with a port which opens into the interior of the hose, and a piston housed within the housing, wherein the piston is arranged for being driven in one direction by entry of water into the housing through the port as a consequence of the increase in pressure of the water in the hose, to thereby produce the increase in buoyancy and for returning in an opposite direction for expelling the water from the housing upon the pressure of the water in the hose being reduced.

This embodiment may also comprise buoyancy means for facilitating the raising and sinking of the hose and which is arranged exterior of the housing, wherein the piston divides the interior of the housing into a first chamber for entry of the water from the hose and a second chamber containing a gas and which opens into the buoyancy means for allowing the gas to be expelled from the second chamber into the buoyancy means to increase the buoyancy upon the piston being driven in the one direction and to be drawn back into the second chamber from the buoyancy means upon the return of the piston in the opposite direction for thereby causing the hose to sink.

Alternatively, the piston may be a double acting piston having a first piston head and a second piston head connected together by a connector, and a first chamber is defined between the housing and the first piston head and a second chamber is defined between the first piston head and the second piston head, wherein water from the hose enters the first chamber for driving the piston in one direction, and the second chamber opens into the buoyancy means for causing gas to be drawn into the buoyancy means from a source of the gas due to suction generated in the second chamber to thereby increase the buoyancy upon the piston being driven in the one direction, and to be expelled from the buoyancy means upon the return of the piston in the opposite direction.

In another embodiment, the pool cleaner apparatus may comprise a housing which opens into the interior of the hose, and a piston housed within the housing for being driven in one direction by flow of water into the housing from the hose as a consequence of the increase in pressure of the water in the hose, to thereby increase the volume of a substantially sealed chamber and so produce the increase in buoyancy while being driven in the one direction.

In such an embodiment the housing may have a first compartment and a second compartment and the piston comprise a double acting piston having a first piston head and a second piston head connected together by a connector, wherein the first piston head is arranged in the first compartment such that a first chamber is defined in the first compartment and the second piston head is located in the second compartment thereby defining a substantially sealed chamber in the second compartment, wherein the flow of water into the first chamber of the housing causes the piston to be driven in the one direction and thereby increase the volume of the scaled chamber and hence increase the buoyancy.

In an alternative embodiment of the invention, the hose may comprise at least one pair of hose sections, wherein one of the hose sections incorporates at least one piston lying alongside a wall defining the interior of that hose section and being held in a fixed position, and the other said hose section incorporates a compartment receiving the or each said piston respectively, and wherein a sealed chamber is defined in the compartment by the corresponding said piston and the pair of hose sections are arranged for sliding along relative to one another with the flow of water along the interior of the hose for causing the volume of the sealed chamber to increase due to resulting relative movement between the piston and the other hose section and thereby produce the increase in buoyancy.

Preferably, the hose will comprise a plurality of the pairs of hose sections arranged one after another.

Most preferably, the one hose section will be provided with a number of fixed pistons spaced apart from each other said around the hose section and received in a corresponding said compartment of the other said hose section, one to each, respectively.

Advantageously, by being able to selectively alter the buoyancy of the hose by simply turning the pump on or off, one can cause the hose to sink in the pool when the pool is desired to be utilised and subsequently cause the hose to be raised to allow cleaning of the pool by the apparatus, without the need for the hose and cleaning head to be removed from the pool. Typically, the buoyancy of the hose will be able to the altered such that the hose sinks to a depth in the pool for allowing normal use of the pool substantially unobstructed by the hose.

The features and advantages of the invention will become further apparent from the following description of preferred embodiments illustrated in the accompanying drawings.

### BRIEF DESCRIPTION OF THE ACCOMPANYING DRAWINGS

FIG. 1 is a schematic view illustrating an embodiment of swimming pool cleaning apparatus of the invention;

FIG. 2 is a schematic view illustrating another embodiment of swimming pool cleaning apparatus of the invention;

FIG. 3 is cross-sectional view of buoyancy means of the pool cleaning apparatus of FIG. 2, in a resting state;

FIG. 4 is a cross-sectional view of buoyancy means of FIG. 3 upon water being pumped along the hose of the pool cleaning apparatus;

FIG. 5 is a schematic diagram illustrating a further embodiment of swimming pool cleaning apparatus of the invention;

FIG. 6 is a schematic diagram illustrating another embodiment of swimming pool cleaning apparatus of the invention;

FIG. 7 is a schematic diagram illustrating an alternative embodiment of a swimming pool cleaning apparatus of the invention;

FIG. 8 is a schematic diagram illustrating a yet further embodiment of a swimming pool cleaning apparatus of the invention; and

FIG. 9 is a schematic diagram illustrating another embodiment.

### DETAILED DESCRIPTION OF PREFERRED EMBODIMENTS OF THE INVENTION

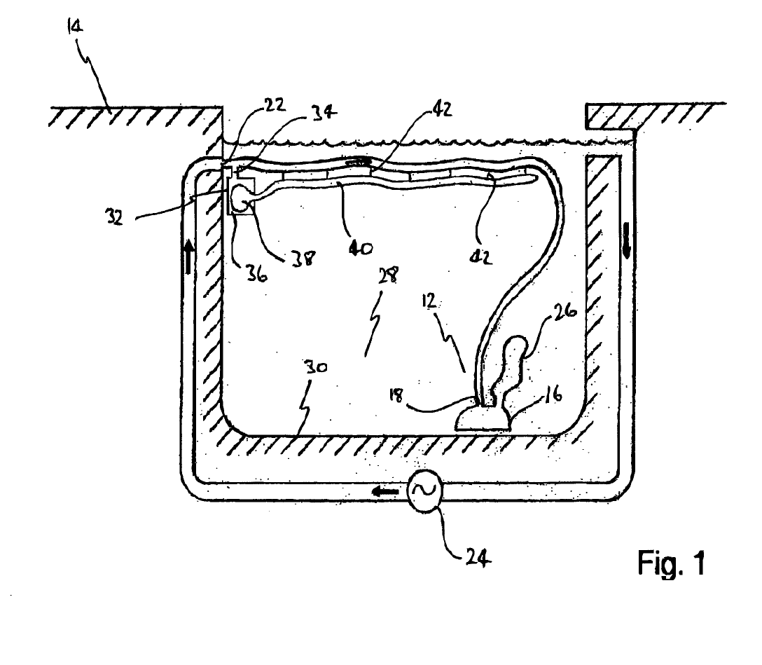

In FIG. 1 there is shown a swimming pool cleaning apparatus 12 in a swimming pool 14 and having a cleaner head 16 attached to an outlet end 18 of a pressure hose 20. An opposite inlet end 22 of the hose is in turn secured to an inlet of the pool through which water is pumped to the cleaner head 16 by filter pump 24. The direction of flow of water through the hose with operation of the filter pump 24 is indicated by the arrows.

The water from the hose 20 is directed into perforated catchment bag 26 so as to thereby create a general inflow of water 28 from the pool and hence draw debris such as leaves and grit that may be present on the pool floor 30 into the catchment bag as the cleaner head is moved across the pool floor, as is conventionally known. While the water is able to pass through perforations in the catchment bag the debris are retained inside the bag.

The cleaning apparatus 12 has a stiff housing 32 that is secured to and opens into the interior of the hose 20 through connector tube 34. The housing 32 is filled with water indicated by the numeral 36 and houses a deformable air reservoir 38 which opens into buoyancy means in the form of a bladder 40 located exterior of the housing 32. The bladder is secured along its length to hose 20 by ring clips 42 as indicated which couple with corresponding attachments on the host and bladder, respectively. However, any clip system deemed suitable may be used. The hose 20 and the housing 32 may be made of any appropriate plastics material.

Water is forced into the housing 32 when water flows from the hoses inlet end 22 to the cleaner head 16 with operation of the filter pump 24. The resulting increase in water pressure in the housing 32 causes the air reservoir 38 to be compressed and air contained therein to be forced into the bladder 40 so that the buoyancy of the hose thereby increases and the hose is caused to rise within the pool.

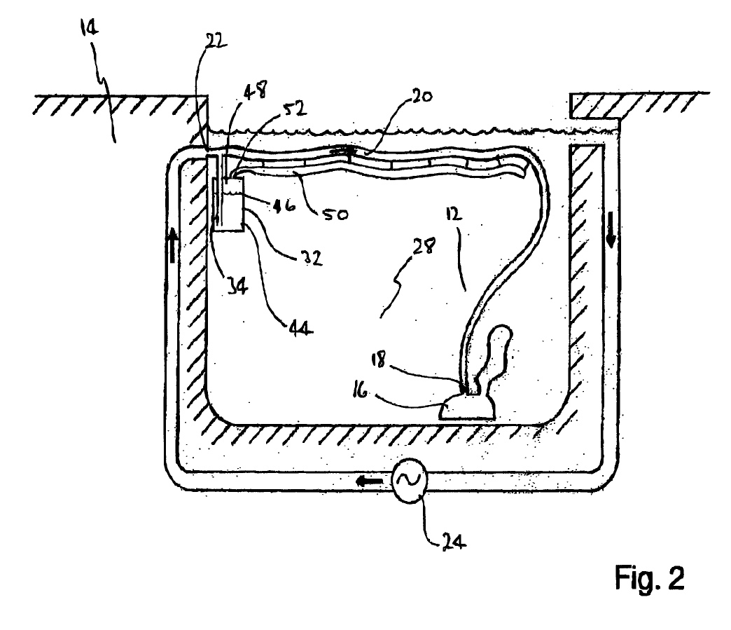

The cleaning apparatus shown in FIG. 2, is not provided with an air reservoir 38. Rather, the connector tube 34 simply opens into a bottom region 44 of housing 32. Accordingly, when water is forced into the housing with operation of the pump, the air-water interface 46 rises within the housing 32 causing the air 48 contained within the housing to be forced into bladder 50 through port 52 so as to provide an increase in buoyancy as in the arrangement shown in FIG. 1.

Halting the flow of water through hose 20 by stopping operation of the pump reduces the water pressure in the housing 32 allowing the air to move from the bladder back into the air reservoir 38 or the housing 32 so that the hose sinks in the pool with the consequent reduction of the buoyancy of the hose. However, the time required for the hose to sink can be relatively long. In order to hasten the return of the air, the bladder 40 or 50 may be adapted to actively return to its resting state when the flow of water through the hose has ceased, so that the air is actively forced from the bladder and the hose is able to sink more quickly.

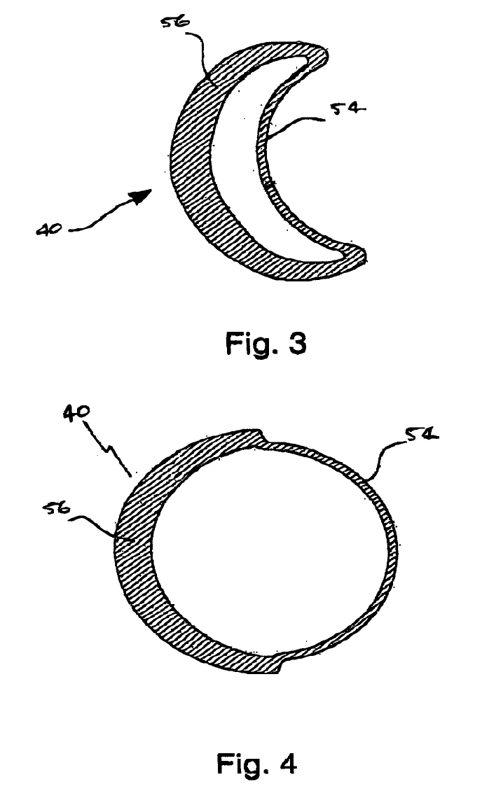

For instance, the bladder 40 or 50 may be formed from a suitably resilient material such as silicone rubber or ultra high density polyvinyl chloride (PVC), and be shaped as shown in FIG. 3. In this instance, the bladder has a crescent shaped cross-section in a plane lying perpendicular to tho longitudinal axis of the bladder, and incorporates a longitudinally extending wall region 54 having a thickness that is substantially reduced compared to the remainder of the wall 56 forming the bladder.

As will be understood, when the bladder inflates, wall region 54 preferentially balloons outwardly relative to the remainder of the side wall as shown in FIG. 4. Upon removal of the water pressure acting on the air reservoir 38 or in the housing 32 when flow of water through the hose 20 has ceased, the wall region 54 of the bladder actively returns to its resting position due to the action of a restoring force resulting from the resilience of the material from which the bladder is formed so that the volume of air within the bladder decreases.

The air reservoir 38 may also or alternatively, be adapted to actively return to its resting state with removal of the water pressure acting on it.

It will be understood, however, that it is not necessary for the air reservoir or the bladder to incorporate regions of reduced wall thickness to achieve the return to its resting state following deformation. More particularly, restoration to the resting state may be achieved solely by the bladder or the air reservoir having sufficient resilience or be otherwise formed, to be self restoring.

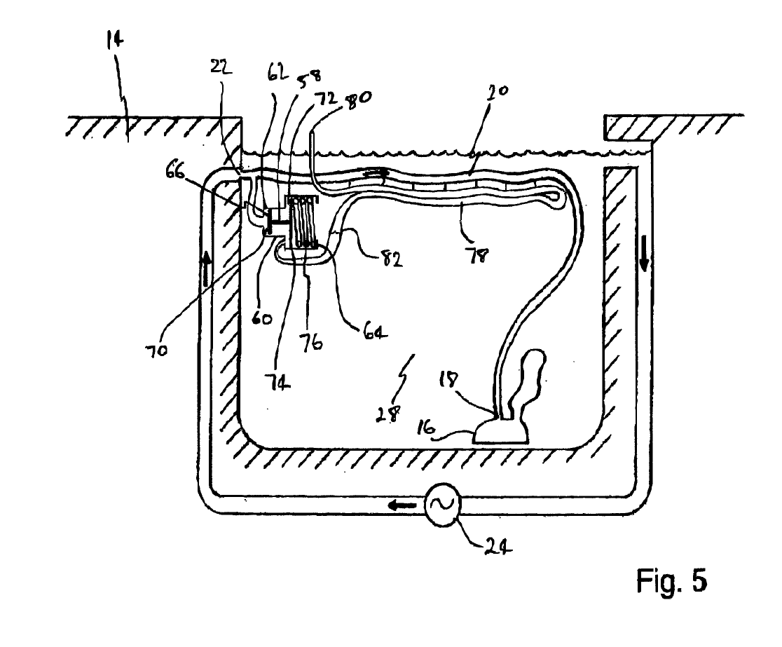

In the embodiment shown in FIG. 5, a double-acting piston 58 is arranged in a housing 60 and is able to reciprocate between the opposite ends 62 and 64 of the housing. The piston is provided with a first piston head 66 that sealingly engages the wall 68 and divides the housing into a pressure chamber 70 and a suction chamber 72, and a second piston head 74 that also scalingly engages with the housing wall and which is seated against a spring 76. The second piston head has a larger diameter than the first piston head and accordingly, the suction chamber has a larger volume per unit length that the pressure chamber.

When water is pumped through the hose 20 to the cleaner head 16, water pressure in the pressure chamber 70 increases causing the piston to be forced along the housing against the action of the spring 76. Due to the movement of the piston, water present in elongate tube 78 is drawn into the suction chamber 72 and as a result, air is drawn into the tube from the atmosphere through a breather opening 80 of the tube. Consequently, buoyancy is increased and the hose rises in the swimming pool 14. When the flow of water through the hose is halted, the pressure acting on the piston in pressure chamber 70 decreases sufficiently for the compressed spring 76 to return the piston 58 to its initial position and water present in the suction chamber 72 to be expelled back into tube 78. The air-water interface in the tube 78 is indicated by the number 82.

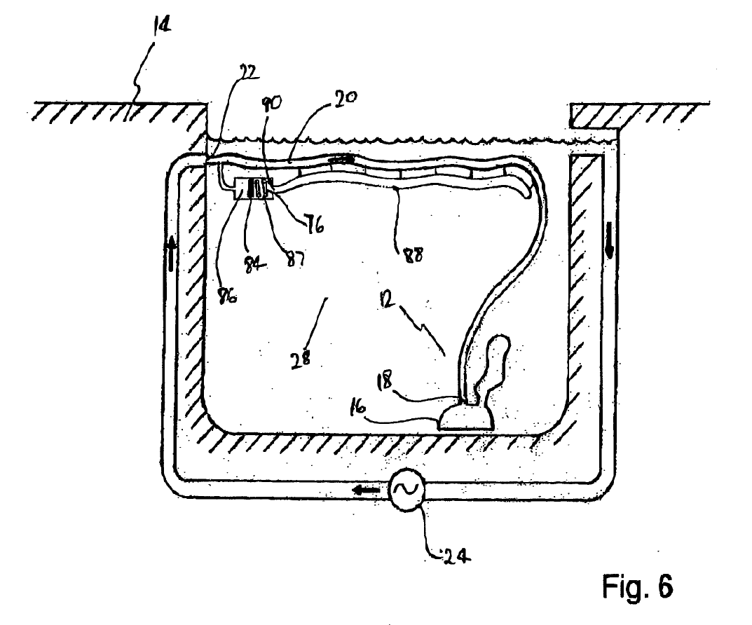

In the arrangement if FIG. 6, a piston 84 is again located within a housing 60 and is seated against a spring 76. However, in this case, when the piston travels along the housing against the action of the spring as a result of an increase in water pressure in chamber 86 due the flow of water through the hose 20 to the cleaner head 16, air is forced from chamber 87 directly into bladder 88 through opening 90 to thereby increase the buoyancy of the hose and so cause the hose 20 to rise in the pool. Again, when the flow of water through the hose 20 is halted, the compressed spring acts to return the piston to its initial position and at the same times cause air to be withdrawn from the bladder back into chamber 87 so that buoyancy is reduced and the hose sinks in the pool.

Discrete weights may be attached to the hose 20 of embodiments of the invention in order that the hose be sufficiently weighted to enable it to sink to a sufficient depth for allowing substantially unobstructed use of the pool when the flow of water through the hose 20 is halted. Although, not shown, a float will generally be provided to hold a breather opening such as 80, above the water. Rather than being open to the atmosphere, the breather opening may open into a deformable air reservoir from which air is able to be drawn in use. Such an air reservoir may also be adapted to actively return to its resting position following deformation, in the manner as described above.

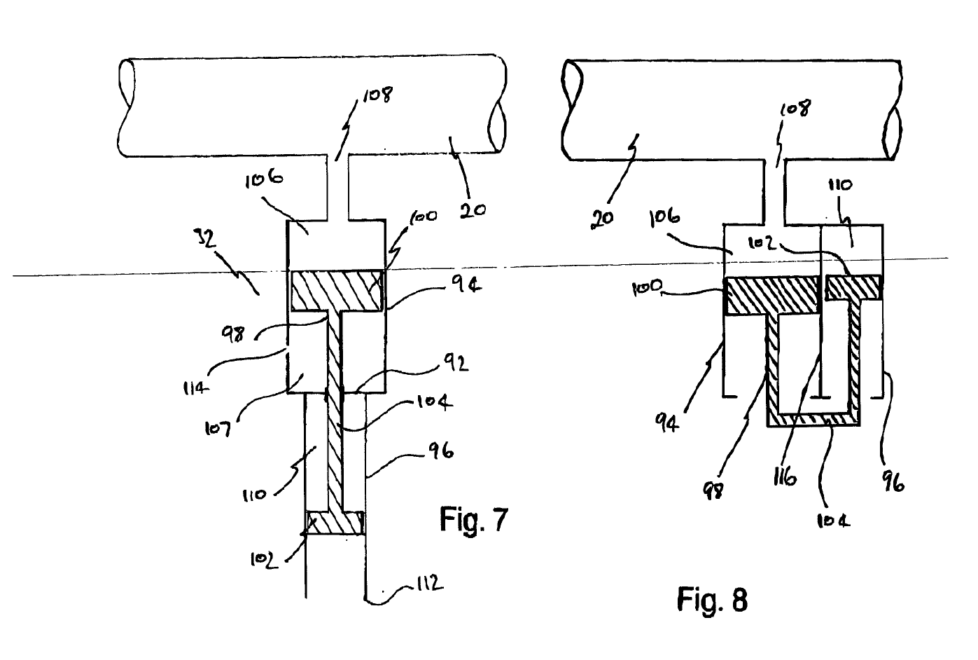

Turning now to FIG. 7, there is shown another embodiment of the invention. In this arrangement, the housing 32 incorporates a partition wall 92 dividing the housing into a first compartment 94 and a second compartment 96. A double acting piston 98 is arranged in the housing and comprises a first piston head 100 connected to a second piston head 102 via a stiff connector rod 104. The first piston head 100 is arranged in the first compartment 94 dividing the first compartment into a first chamber 106 for receiving water from the hose 20 through inlet port 108 when water is pumped along the hose to the cleaner head 16 in use, and a second chamber 107. A suction chamber 110 is defined between the second piston head 102 and the partition wall 92 of the housing.

The connector 104 sealingly passes through the partition wall 92 of the housing such that the suction chamber is thereby sealed against leakage of water from the second chamber during movement of the piston along the housing.

The second compartment 96 of the housing opens to the exterior of the apparatus at end 112, and a further port 114 is defined in the housing for allowing flow of water from the pool into and from the second chamber 107. As can be seen, the volume of the first chamber is significantly larger than the volume of the second chamber per unit length of those chambers.

In operation, flow of the water into the first chambers drives the piston 98 along the housing 32 causing water contained in the second chamber to be expelled from the housing through port 114 and the volume of the suction chamber to be increased. As the volume of the sealed suction chamber is increased the buoyancy is also increased and the hose is caused to rise in the pool.

The embodiment shown in FIG. 8 is similar to that shown in FIG. 7. However, in this instance, the first and second compartments 94 and 96 of the housing 32 are arranged side by side to one another and are defined by a common partition wall 116 of the housing. As with the FIG. 7 embodiment, a first chamber is defined in the first compartment for receiving water from the interior of the hose 20 through an inlet port 108, and a suction chamber 110 is defined in the second compartment. However in this case, both the first and second compartments open to the exterior of the housing. Again, the volume of the suction chamber 110 is caused to be increased as the piston is driven along the housing with the entry of the water into the first chamber 106, such that the buoyancy is increased and the hose caused to rise in the pool.

Upon the pressure of the water in the housing being reduced, the suction generated in the suction chamber of the apparatus shown in the FIG. 7 or 8 embodiment as a result of the travel of the corresponding piston causes the corresponding piston to return along the housing and the water to be expelled from the first chamber.

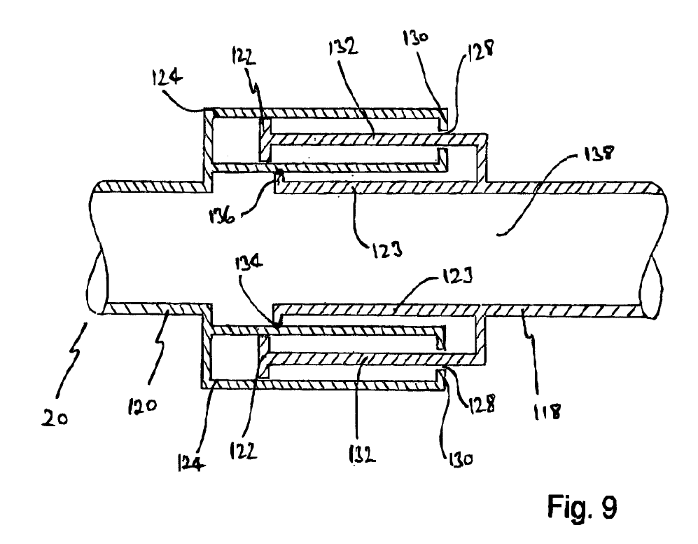

Turning now to FIG. 9, there is shown yet another embodiment of the present invention. In this instance, the hose 20 comprises a first hose section 118 and a second hose section 120. The first hose section incorporates a pair of fixed pistons arranged on either side of the first hose section and lying alongside a wall 123 defining the interior of that hose section. Corresponding compartments 124 are defined on the second hose section 120 and receive the pistons 122, one to each, respectively, Suction chambers 126 are thereby defined in the compartments 124 by virtue of the reception of the pistons therein. While the suction chambers are sealed against inflow of water from the pool by the pistons, the water in the pool is able to substantially freely enter the remainder of the compartments 124 through slots 128 defined in the ends 130 through which the shafts 132 of the pistons extend.

A seal in the form of an O-ring 134 received in a circumferential groove defined in flange 136 of the first hose section inhibits loss of water flowing along the interior 138 of the hose in use.

In use, the increase in pressure of the water in the interior 138 of the hose with flow of the water to the cleaning head causes the first hose section 118 and the second hose section 120 to slide relative to one another such that the pistons 122 are drawn along the compartments 124 causing the volume of the suction chambers 126 to increase. The increase in the volume of the suction chambers increases the buoyancy of the hose and causes the hose to float in the pool. Upon the pressure of the water in the hose being reduced, suction in the suction chambers 126 generated by the travel of the pistons along the compartments 124 causes the pistons to be retuned to their initial positions whereby the buoyancy is decreased and the hose is caused to sink in the pool.

To minimise friction between the hose sections, the respective piston and compartment sets are arranged around the hose at 180° with respect to each other.

The hose may comprise a plurality of pairs of such hose sections arranged one after another. In this instance, it will be understood that each end of each hose section will be provided with compartments 124 or fixed pistons 122 as required which are coupled with corresponding fixed pistons and compartments of immediately adjacent hose sections of the hose.

Although the present invention ha& been described hereinbefore with reference to a number of embodiments the skilled addressee will understand that numerous variations and modifications are possible without departing from the scope of the invention.

The claims defining the invention are as follows:

1. A method for selectively raising and sinking a hose of pool cleaning apparatus of the type with a cleaning head for cleaning the bottom of a swimming pool utilising water from the pool, wherein the hose has an inlet end for entry of water into the hose and an opposite end for the water to exit from the hose to the cleaning head, comprising:
pumping water along within thy hose toward the cleaning head such that pressure of the water is increased to thereby cause an increase in buoyancy such that the hose rises in the pool; and
reducing the pressure of the water within the hose whereby the buoyancy decreases and the hose sinks in the pool.

2. A method according to claim 1 wherein the reducing of the pressure of the water in the hose comprises reducing the rate at which the water is pumped along the hose.

3. A method according to claim 1 wherein the increase in buoyancy causes at least some of the hose to rise and float on the surface of the pool.

4. A method according to claim 1 wherein the decrease in buoyancy causes the hose to sink to a depth in the pool for allowing normal use of the pool substantially unobstructed by the hose.

5. A method according to claim 1 wherein the pool cleaning apparatus incorporates a housing which opens into the interior of the hose, and wherein the pumping of the water along the hose causes water to flow into the housing from the hose whereby the buoyancy is caused to be increased.

6. A method according to claim 5 wherein the pool cleaning apparatus further comprises buoyancy means arranged for exterior of the housing for facilitating the raising and sinking of the hose, and the housing houses a gas reservoir that opens into the buoyancy means, and wherein the flow of water into the housing forces gas from the gas reservoir into the buoyancy means to thereby increase the buoyancy.

7. A method according to claim 6 wherein the buoyancy means is secured alongside the hose.

8. A method according the claim 5 wherein the pool cleaning apparatus further comprises buoyancy means arranged exterior of the housing for facilitating the raising and sinking of the hose, wherein the housing is partially filled with a gas and the flow of water into the housing forces at least some of the gas from the housing into the buoyancy means to thereby increase the buoyancy.

9. A method according to claim 8 wherein the water flows into a lower region of the housing from an inlet port and the gas is forced from the housing through an outlet port defined in an upper region of the housing.

10. A method according to claim 8 wherein the buoyancy means is secured alongside the hose.

11. A method according to claim 5 wherein the housing houses a piston and the flow of water into the housing from the hose drives the piston in one direction to produce the increase in buoyancy, and wherein said reducing of the pressure of the water in the hose causes the piston to return in an opposite direction decreasing the buoyancy and expel the water from the housing.

12. A method according to claim 11 wherein the driving of the piston in the one direction causes the volume of a substantially sealed chamber defined in a buoyancy compartment of the pool cleaning apparatus to be increased to thereby produce the increase in buoyancy.

13. A method according to claim 12 wherein the buoyancy compartment is defined in the housing.

14. A method according to claim 1 wherein the hose comprises at least one pair of hose sections, and one of the hose sections incorporates a piston lying alongside a wall defining the interior of that hose section and being held in a fixed position, and the other said hose section incorporates a compartment receiving the or each said piston respectively, and wherein a scaled chamber is defined in the compartment by the corresponding said piston, and the increase in pressure of the water in the hose causes the pair of hose sections to slide along relative to one another such that the volume of the sealed chamber increases due to the resulting relative movement between the piston and the other hose section and the increase in buoyancy is thereby produced.

15. A method according to claim 6 or 8 wherein the buoyancy means is a bladder.

16. Pool cleaning apparatus of the type with a cleaning head for cleaning the bottom of a swimming pool utilising water returning to the pool, and further comprising:
a hose for placement in the pool and directing the water from a pump to the cleaning head, the hose having an inlet end for entry of the water into the hose and outlet end for passage of the water from the hose to the cleaning head;
wherein the hose is adapted for being raised in the pool from an initial position to a working position by an increase in buoyancy caused by increased pressure of water in the hose with flow of the water along the hose to the cleaning head, and subsequently sinking from the working position upon the pressure of the water in the hose being reduced.

17. Pool cleaning apparatus according to claim 16 further comprising buoyancy means for facilitating the raising and sinking of the hose and arranged for being at least partly filled with a gas as a consequence of the increase in pressure of the water in the hose and thereby provide the increase in buoyancy, and for holding the gas until pressure of the water in the hose is reduced.

18. Pool cleaning apparatus according claim 17 further comprising a housing which opens into the interior of the hose and houses a gas reservoir that opens into the buoyancy means, wherein the buoyancy means is arranged exterior of the housing for receiving the gas from the gas reservoir upon the gas being expelled from the reservoir by the flow of water into the housing from the hose.

19. Pool cleaning apparatus according to claim 17 further comprising a housing containing the gas and for receiving water into a bottom region of the housing from the hose as a consequence of the increase in pressure of the water in the hose and having a port defined in an upper region of the housing for passage of the gas into the buoyancy means upon being expelled from the housing by the flow of the water into the bottom region of the housing and for return of the gas into the housing from the buoyancy means upon pressure of the water in the hose being reduced.

20. Pool cleaning apparatus according to claim 16 further comprising:
a housing with a port which opens into the interior of the hose; and
a piston housed within the housing;
wherein the piston is arranged for being driven in one direction by flow of water into the housing through the port as a consequence of the increase in pressure of the water in the hoses to thereby produce the increase in buoyancy and for returning in an opposite direction for expelling the water from the housing upon the pressure of the water in the hose being reduced.

21. Pool cleaning apparatus according to claim 20 further comprising buoyancy means for facilitating the raising and sinking of the hose and arranged exterior of die housing, wherein the piston divides the interior of the housing into a first chamber and a second chamber and the port is located for flow of the water into the first chamber, wherein the second chamber contains a gas and another port which opens into the buoyancy means is defined in the housing for allowing the gas to be expelled from the second chamber into the buoyancy means to increase the buoyancy upon the piston being driven in the one direction and to be drawn back into the second chamber from the buoyancy means upon the return of the piston in the opposite direction for causing the hose to sink.

22. Pool cleaning apparatus according to claim 21 wherein the buoyancy means is secured alongside the hose.

23. Pool cleaning apparatus according to claim 21 further comprising spring means arranged for causing the piston to return in the opposite direction.

24. Pool cleaning apparatus according to claim 23 wherein the spring means is arranged in the second chamber for being compressed by the piston upon the piston being driven in the one direction.

25. Pool cleaning apparatus according to claim 20 further comprising buoyancy means for facilitating the raising and sinking of the hose and arranged exterior of the housing, wherein the piston is a double acting piston having a first piston head and a second piston head connected together by a connector, and a first chamber is defined between the housing and the first piston head and a second chamber is defined between the first piston head and the second piston head, and wherein the port is located for allowing the flow of water from the hose into the first chamber, and the second chamber opens into the buoyancy means through a different port defined in the housing for causing gas to be drawn into the buoyancy means from a source of the gas due to suction generated in the second chamber to thereby increase said buoyancy upon the piston being driven in the one direction, and be expelled from the buoyancy means for causing the hose to sink upon the return of the piston in the opposite direction.

26. Pool cleaning apparatus according to claim 25 wherein the volume of the second chamber is larger than the volume of the first chamber per unit length of those said chambers.

27. Pool cleaning apparatus according to claim 25 wherein the buoyancy means is partially filled with a liquid in use for being drawn into the second chamber through the different port upon the piston being driven in the one direction.

28. Pool cleaning apparatus according to claim 25 further comprising spring means for returning the piston in the opposite direction.

29. Pool cleaning apparatus according to claim 25 wherein the spring means is arranged in the second chamber for being compressed by the piston upon the piston being driven in the one direction.

30. Pool cleaning apparatus according to claim 25 wherein the buoyancy means is secured alongside the hose.

31. Pool cleaning apparatus according to claim 19 wherein the piston is arranged for increasing the volume of a sealed chamber to thereby produce the increase in buoyancy while being driven in the one direction.

32. Pool cleaning apparatus according to claim 31 wherein the second chamber is defined in a buoyancy compartment of the housing.

33. Pool cleaning apparatus according to claim 20 wherein the housing has a first compartment and a second compartment and the piston is a double acting piston having a first piston head and a second piston head connected together by a connector, and the first piston head is arranged in the first compartment such that a first chamber is defined in the first compartment and the second piston head is located in the second compartment thereby defining a substantially sealed chamber in the second compartment, and wherein the port is provided for enabling the flow of the water from the hose into the first chamber to cause the piston to be driven in the one direction and the volume of the sealed chamber to thereby be increased to thereby produce the increase in buoyancy and generate suction in the sealed chamber for facilitating the return of the piston in the opposite direction.

34. Pool cleaning apparatus according to claim 33 wherein the first piston head divides the first compartment into the first chamber and a second chamber, and the second chamber opens to the exterior of the housing through another port defined in the housing.

35. Pool cleaning apparatus according to claim 33 wherein the connector sealingly passes through a wall of the housing from the first compartment into the second compartment.

36. Pool cleaning apparatus according to claim 33 wherein the volume of the first chamber is larger than the volume of the second chamber per unit length of those said chambers.

37. Pool cleaning apparatus according to claim 16 wherein the hose comprises at least one pair of hose sections, and one of the hose sections incorporates at least one piston lying alongside a wall defining the interior of that hose section and being held in a fixed position, and the other said hose section incorporates a compartment receiving the or each said piston respectively, and wherein a sealed chamber is defined in the compartment by the corresponding said piston and the pair of hose sections are arranged for sliding along one another with the increase in pressure of the water in the hose, for causing the volume of the sealed chamber to be increased duo to resulting relative movement between the piston and the other hose section and thereby produce the increase in buoyancy.

38. Pool cleaning apparatus according to claim 37 wherein the hose comprises a plurality of pairs of the hose sections arranged one after another.

39. Pool cleaning apparatus according to claim 37 wherein the one said hose section is provided with a number of fixed pistons spaced apart from each other said around the hose and received in a corresponding said compartment of the other said hose section, one to each respectively.
